(19) United States
(12) Patent Application Publication
(10) Pub. No.: US 2004/0210630 A1
(43) Pub. Date: Oct. 21, 2004

(54) Systems and methods for discovering, acquiring and maintaining nodes in a logical network

(75) Inventors: Guillaume Simonnet, Bellevue, WA (US); Harry S. Pyle, Bellevue, WA (US); Richard Hasha, Seattle, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/417,691

(22) Filed: Apr. 17, 2003

(51) Int. Cl. G06F 15/16

(52) U.S. Cl. 709/203

(57) ABSTRACT

Systems and methods for forming and maintaining a secure logical network are provided, thereby enabling confidentiality and authenticity in the exchange of information between nodes on the logical network. In one embodiment, an Address Space Arbitrator (ASA) is a component responsible for the management of a logical network. The ASA performs at least three related functions: discovery, acquisition and maintenance. The way each of discovery, acquisition and maintenance are performed and optimized in accordance with the invention contributes to keeping the logical network secure, and communications robust, even though the underlying physical network is a shared (public) and unreliable media.

### RELATED APPLICATIONS

The present invention is related to commonly assigned copending U.S. patent application Ser. No. 09/556,279 (the '279 application), filed Apr. 24, 2000, entitled “System for Networked Component Address and Logical Network Formation and Maintenance,” commonly assigned copending U.S. patent application Ser. No. 10/251,457 (the '457 application), filed Sep. 19, 2002, entitled “Systems and Methods for Providing Automatic Network Optimization with Application Variables” and commonly assigned copending U.S. patent application Ser. No. 10/251,370 (the '370 application), filed Sep. 19, 2002, entitled “Systems and Methods for Providing Presence Tracking in a Distributed Computing System,” all of which are hereby incorporated by reference in their entirety.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 1999-2003, Microsoft Corp.

### FIELD OF THE INVENTION

The present invention is directed to systems and methods for securely and robustly discovering, acquiring and/or maintaining nodes of a secured logical network using an underlying public, or shared, and unreliable physical medium.

### BACKGROUND

Distributed computing is a field of study that has received increased attention and study in recent years, as network interconnectivity, from wired to wireless, of computing devices and objects continues to mature and computing devices and objects of all kinds continue to proliferate. To this end, a variety of protocols can be used to enable computing devices and objects of all sorts to communicate with one another in a manner that is independent of the particularities of the source and target computing devices.

Examples of such protocols that have been developed include Simple Control Protocol (SCP), ×10, and CEBus®. SCP, for instance, is a lightweight device-control protocol that allows manufacturers to create small, intelligent devices that can communicate with each other in a secure and robust manner over low-speed communication networks such as household power lines. With SCP, devices with limited computing power and memory resources-such as light switches, alarm clocks, and appliances-can be part of a peer-to-peer network of other SCP devices. Devices in an SCP network can also participate in more sophisticated Universal Plug and Play (UPnP) networks through a software component called a bridge, such as a UPnP to SCP bridge.

The following examples describe some typical scenarios that SCP and other protocols can make possible. Automated lights and light switches can be enabled using SCP such that light switches and fixtures can be controlled from a PC. A homeowner can change “which switches control which lights” without needing to call an electrician to rewire the physical circuits. Interactions among small appliances can also be enabled using SCP. For instance, an alarm clock can automatically start a coffee maker. Interactions among SCP and UPnP devices can also be enabled using SCP. For instance, a homeowner can place a tape in a UPnP-capable VCR and press “Play.” The VCR then sends a UPnP event to a rules engine, which places the room into a home theater mode. The rules engine then turns the UPnP TV on and connects it to the VCR audio and video outputs. Then, through an SCP to UPnP bridge, the engine tells the SCP room lights to dim and closes the SCP blinds.

One can thus readily see that SCP, and other logical networks like SCP, are powerful vehicles for communication across a variety of computing devices. One can also appreciate that a variety of scenarios are possible with SCP, when one considers the possibility of any computing device or object being able to communicate simply and easily with any other computing device or object.

However, some of the above-described scenarios presume ideal, or near ideal, network conditions, and in contrast, often the actual physical medium utilized for communications in a logical network is not ideal. For instance, in the case of power line carrier (PLC) communications, data is not always guaranteed to arrive at its destination, or when it does, there may be some interference along the way that distorts the data or renders it unrecognizable. Similarly, on the reception side of data communications, interference can also be of impact. For instance, with compact fluorescent bulbs, there can sometimes be bad switching harmonic energy that interferes with data communications. Thus, when discovering, acquiring and/or maintaining nodes, objects or devices a logical network, it would be desirable for the communications protocol utilized to be robust enough to account for less than ideal characteristics of the underlying physical network.

Moreover, in a day and age when security and privacy in connection with network activity is paramount due to the ease with which digital user data can be reproduced, analyzed and distributed by unwanted listeners to network traffic, it would be desirable to provide a communications protocol with sufficient security measures to prevent the unauthorized interference with a network.

The Dynamic Host Configuration Protocol (DHCP) is an Internet protocol for automating the configuration of computers that use TCP/IP. DHCP can be used to automatically assign IP addresses, to deliver TCP/IP stack configuration parameters such as the subnet mask and default router, and to provide other configuration information such as the addresses for printer, time and news servers. While DHCP provides robust communications for some physical media, it is best suited for private media, not shared with the public at large. In other physical media, such as power line, the medium by definition is shared, for instance, with one's neighbors, making DHCP inappropriate alone. Moreover, DHCP is too heavy of a protocol to deliver an adequate solution for the limited bandwidth and signal characteristics of power line.

It would thus be desirable to provide a protocol that enables both secure and robust communication when performing discovery, acquisition and maintenance functions with respect to nodes, objects and devices on a logical network. In this regard, it would be desirable to allow the formation and maintenance of secure logical networks, thereby enabling confidentiality and authenticity in the exchange of information between nodes on the logical network.

Commonly assigned U.S. patent application Ser. No. 09/556,279 (the '279 application), filed Apr. 24, 2000, entitled “System for Networked Component Address and Logical Network Formation and Maintenance,” describes a system for forming and maintaining one or more networks of devices connected to a shared media. Aspects taught in the '279 application include processes for: (a) forming a logical network on the shared media, (b) discovering devices connected to the shared medium, (c) assigning (or acquiring) devices to a logical network and (d) maintaining a logical network. Another aspect of the '279 application includes its teachings related to a message format and protocol for communication over the shared media. The protocol uses a two-level address scheme (e.g., a logical network ID and a device ID) and defines several message types used to support the above processes and other useful features. Each device is expected to have a globally unique device ID (GUID).

The '279 application also includes teachings relating to an address space arbiter (ASA) and, typically, one or more devices attached to the shared media. Moreover, an acquisition authority (AA), interacting with the ASA, is used to complete acquisition of a device by a logical network. As a definitional matter, the term AA, or AA object is utilized herein to refer to a variety of encompassing scenarios including a person or user interacting with hardware/firmware/software to affirm choices for the logical network as well as hardware/firmware/software behaving according to pre-set rules for the logical network. Thus, while the term AA object is utilized herein, this may in part refer to a human entity. An ASA can form a logical network by selecting a possible logical network ID, when first attached to the shared media. The ASA then broadcasts a message addressed to the entire shared media to determine whether the possible ID is already taken. If the possible ID is not taken, the ASA adopts the ID as its logical network ID and can begin acquiring devices.

To join a logical network, a device attached to the shared media broadcasts an announce message addressed to the entire shared media. This can be initiated by the device itself, or at the request of an ASA attached to the shared media. ASAs receiving the announce message then determine whether the device is a “discovered” device. If the device is also not acquired, the AA decides whether to authorize the ASA to acquire the discovered device. If authorized, the ASA then assigns an available device ID to the device. The device ID is unique within the logical network, but does not necessarily have to be globally unique. The ASA helps maintain the logical network by periodically sending a message to each device of the logical network and waiting for the appropriate response from that device.

In this regard, it would be desirable to optimize, or build upon the techniques described in the '279 application in connection with the discovery, acquisition and maintenance of nodes in a logical network formed on a shared, or public, medium.

### SUMMARY OF THE INVENTION

In consideration of the need for a lightweight, yet secure and robust protocol for a shared physical medium, the invention provides systems and methods for forming and maintaining a secure logical network, thereby enabling confidentiality and authenticity in the exchange of information between nodes on the logical network. In one embodiment, an Address Space Arbitrator (ASA) is a component responsible for the management of a logical network. As such, ASA can perform at least three functions: discovery, acquisition and maintenance. The way each of discovery, acquisition and maintenance are performed and optimized in accordance with the invention contributes to keeping the logical network secure, and communications robust, even though the underlying physical network is a shared (public) media.

Other features and embodiments of the present invention are described below.

### BRIEF DESCRIPTION OF THE DRAWINGS

The systems and methods for discovering, acquiring and maintaining nodes and devices in a logical network in accordance with the present invention are further described with reference to the accompanying drawings in which:

FIG. 1A is a block diagram of one example of a protocol in connection with which the invention may be implemented;

FIG. 1B is a block diagram of an exemplary interconnection of logical networks that may be achieved in connection with the discovery, acquisition and maintenance of the invention;

FIG. 1C is a block diagram of exemplary data used to send messages to an unacquired node in a confidential and authentic way in accordance with the invention;

FIG. 2A is a block diagram representing an exemplary network environment having a variety of computing devices in which the present invention may be implemented;

FIG. 2B is a block diagram representing an exemplary non-limiting computing device in which the present invention may be implemented;

FIG. 3A is an exemplary block diagram of a network with unacquired nodes for discovery in accordance with the invention;

FIG. 3B is an exemplary flow diagram for a discovery process in accordance with the invention;

FIG. 4 is an exemplary flow diagram for an acquisition process in accordance with the invention;

FIG. 5A is an exemplary flow diagram for a test path process in accordance with the invention; and

FIG. 5B is an exemplary flow diagram for a maintenance process in accordance with the invention.

### DETAILED DESCRIPTION OF THE INVENTION

Overview

This invention relates to a security model for an ASA, a component responsible for the management of logical networks, such as an SCP logical network. The ASA allows the formation and maintenance of secure logical networks, enabling confidentiality and authenticity in the exchange of information between nodes on the logical network. The ASA performs three related functions in accordance with the invention: discovery, acquisition and maintenance. In one aspect, each of these functions presents innovations with regards to keeping the logical network secure, even though the underlying physical network is a shared (public) media.

Exemplary Logical Network—Overview of ASA with SCP

As mentioned, embodiments of the invention apply to protocols. An overview of SCP is provided herein. Various implementations of SCP support networks that use standard electrical wiring as the physical medium connecting the devices, e.g., the Power Line Carrier (PLC) implementation of SCP. Other SCP implementations for other physical network media such as radio frequency and infrared transmissions can also be utilized.

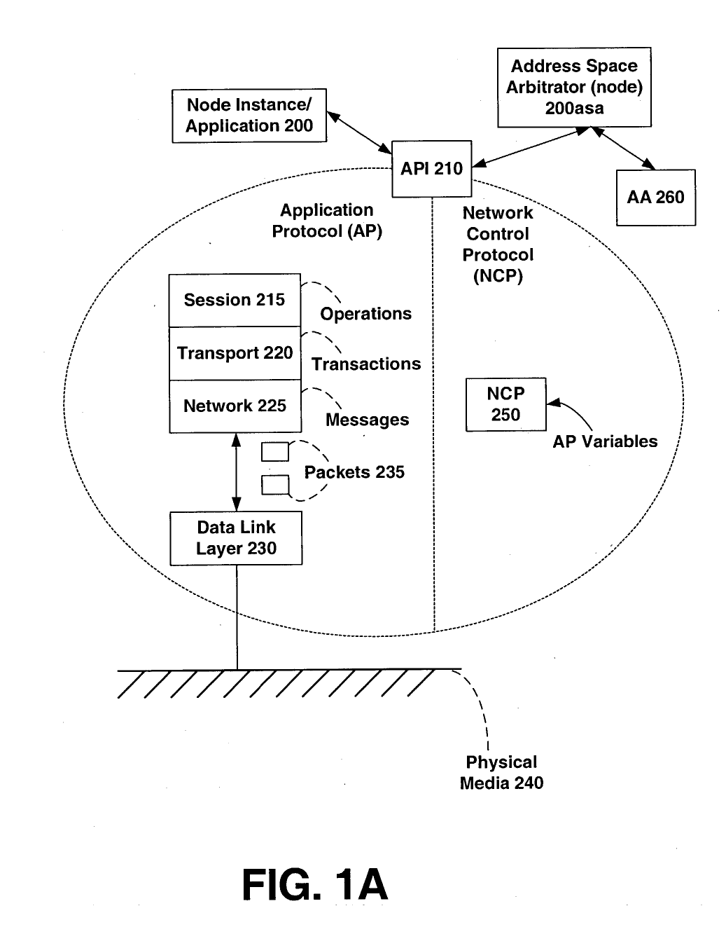

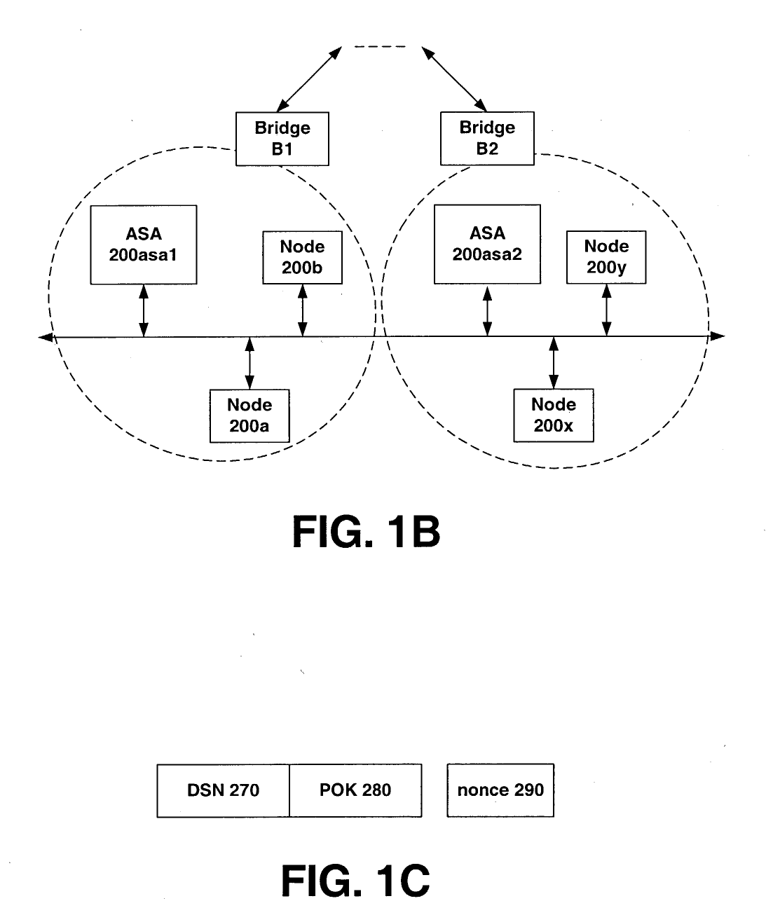

FIG. 1A illustrates a block diagram overview of an exemplary SCP stack, and exemplary description of various aspects thereof follows. SCP is a protocol that makes use of a physical medium 240, such as PLC. A protocol stack is a way to manage and organize nodes 200 in a distributed system via an API 210, or other object. A node 200 can be either a software object or a hardware object, or a combination of both. One node, the address space arbitrator 200asa, handles discovery, acquisition and maintenance of nodes on the logical network. There is one ASA 200asa per logical network. An ASA 200asa includes or communicates with an acquisition authority (AA) 260. The ASA operates with respect to the NCP layer 250, as an abstraction of the underlying data link layer, and interacts with network layer 225. There is one ASA per logical network, whereby there is no interconnectivity of logical networks, except where there is a UPnP bridge present to bridge the logical networks (See e.g., FIG. 1B, wherein a first network having ASA 200asa1, node a, node b, etc. is connected to a second network having ASA 200asa2, node x, node y, etc. via bridges b1 and b2).

A protocol comprises an application protocol (AP) and a network control protocol. The application protocol side implements a session layer 215, a transport layer 220 and a network layer 225 which handle operations, transactions and messages, respectively. A data link layer 230 resides on top of the physical medium 240, and handles the packets 235 delivered and received by the network layer 225. A protocol encrypts and decrypts communications for security purposes. In one implementation, message communications make use of a physical address used for physical addressing of nodes, which includes a device serial number (DSN) 270, a private ownership key (POK) 280 and a nonce 290, as illustrated in FIG. 1C. DSN 270 is the physical address portion and POK 280 and nonce 290 are utilized for encryption. This enables an ASA to securely distribute a shared network key to each device to participate in the logical network. This shared key (secret) allows for each node to communicate securely with other nodes on the logical network.

An SCP device is a component that uses the SCP to communicate with other devices connected to the same physical medium. SCP accommodates both “hard” and “soft” devices. A hard device is a piece of hardware such as a dimmer switch or a motion sensor. For hard devices, SCP is implemented as a set of integrated circuit (IC) chips that handle all of the protocol-level communication tasks for a device. This chipset, when added to a device, forms a communication subsystem that handles of the protocol-level communication tasks for the device.

A soft device is a software application that runs on a PC under the SCP device emulation environment. This environment emulates the communication subsystem provided by the SCP chipset and allows multiple soft devices running on the same PC to share the same channel of communications to the physical network.

At its simplest, an SCP network consists of two or more SCP devices and the physical medium connecting the devices. A network can also include other software components that run on a PC, such as the SCP to UPnP bridge, the Address-Space Arbitrator, and the Physical Network Manager.

The SCP to UPnP bridge is a special soft device that allows SCP devices to interoperate with UPnP devices. The bridge extends the full capabilities of UPnP to small devices that are not capable of implementing TCP/IP and native UPnP stacks. For example, the bridge allows the properties of an SCP device to be set by using messages sent across a TCP/IP network. All SCP device property relationships are established at the UPnP level through the bridge and propagate down to the SCP device level. The bridge also allows SCP devices to interoperate with devices that use other control protocols. If a bridge exists between those devices and a UPnP network, SCP devices can use UPnP as a common communication language.

The Address-Space Arbitrator (ASA) is another special soft device that forms and manages a logical network of SCP devices. A logical network is a group of devices that are logically separate from other devices connected to the same physical network medium. SCP can support one or more logical networks within the same physical network. For example, a physical network can include a logical network for security devices, another for lighting devices, and yet another for audio-visual equipment. Logical networks are also used in environments such as apartment buildings where adjacent apartments share the same power line. Each apartment uses its own logical network so it does not interfere with the operation of the devices in a neighboring apartment.

The Physical Network Manager is a software component that runs on a PC. It manages the connection to the physical network, allowing multiple soft devices running on the same PC to share the same connection.

An SCP device presents itself on the network as a root device with optional nested sub-devices. Each device (or sub-device) supports one or more services. A service consists of a group of related properties and actions. Properties describe the state of a service, and actions change or access the state of a service. Taken together, the sub-devices, services, properties, and actions of a device are called its device model. The SCP device model is analogous to a programming object, where an object interface provides access to a set of properties and methods that operate on and describe the state of the object.

The SCP device model is based on the UPnP device model, e.g., the device model for an SCP device is a UPnP device description that has been augmented with SCP data. As a device developer, a device model is developed for the device, creating a binary description that the device uses at runtime.

SCP devices work by exposing their properties and actions to other devices, and by using operations to access the properties and actions of other devices on the network. The operation is the fundamental unit of communication among devices. A device uses operations to set and retrieve property values on other devices, to invoke actions on other devices, and to notify other devices when the value of a property changes.

Devices use operations to accomplish many tasks, and one of the primary tasks involves implementing subscriptions. A subscription is a relationship that one device, called the subscriber, sets up between itself and a property on another device, called the publisher. After a subscription is established, the publisher sends notification messages to the subscriber whenever the value of the property changes.

Devices use subscriptions as the basis for setting up property routes. A property route is a one-way connection between two properties: a source property on a publisher device and a destination property on a subscriber device. When the value of the source property changes on publisher device, the subscriber device updates its destination property with the new value.

To illustrate how subscriptions and property routes work, consider a device that exposes a simple timer service consisting of three properties: Increment, which specifies the timer countdown increment in milliseconds; Value, which specifies the current countdown time; and Trigger, which changes from False to True when Value goes to zero. The service also has three actions: Start, Stop and SetValue. For example, if it is desired that the Timer turn on some lights when the Timer's Value property goes to zero, a third-party (for example, a configuration utility) can tell each light to subscribe to the Timer's Trigger property and create a route between that property and the light's Intensity property. Then, when Trigger property becomes True, each light's Intensity property also changes to True, and the lights come on.

One creates an SCP device by integrating the SCP communication subsystem into the device. For a hard device, this involves incorporating the SCP chipset into the circuitry of the device. For a soft device, it involves implementing code in a PC application that takes advantage of the SCP emulation environment.

The application subsystem connects to the SCP communication subsystem through a serial peripheral interface (SPI) connection. One of the main tasks (besides creating the device model) is to implement a software interface to the SPI connection that allows the device application, running on the application processor, to communication with the communication subsystem. Code is also implemented that allows the device application to control the communication subsystem, using it to communicate with other devices on the network.

To summarize, creating an SCP device involves accomplishing the following tasks. (1) Creating the device model that defines the services, properties, and actions provided by the device, (2) Implementing code in your device application that supports the SPI connection between the application subsystem and the SCP communication subsystem and (3) Implementing code in the application-processor that interacts with the communication subsystem to communicate with other devices in the network.

As mentioned, the '279 application describes a system for forming and maintaining one or more networks of devices connected to a shared media is provided. Aspects of the '279 application include processes for: (a) forming a logical network on the shared media; (b) discovering devices connected to the shared medium; (c) assigning (or acquiring) devices to a logical network; and (d) maintaining a logical network. Another aspect of the '279 application also defines a message format and protocol for communication over the shared media. The protocol uses a two-level address scheme (e.g., a logical network ID and a device ID) and defines several message types used to support the above processes and other useful features. Each device is expected to have a globally unique device ID, called the Device Serial Number (DSN).

A logical network includes an address space arbiter (ASA) and, typically, one or more devices attached to the shared media. An acquisition authority (AA), interacting with the ASA, is required to complete acquisition of a device by a logical network.

An ASA can form a logical network by selecting a possible logical network ID, when first attached to the physical media. The ASA then broadcasts a message addressed to the entire physical network to determine whether the possible ID is already taken. If the possible ID is not taken, the ASA adopts the ID as its logical network ID and can begin acquiring devices.

To join a logical network, a device attached to the shared media broadcasts an announce message addressed to the entire shared media. This is initiated at the request of an ASA attached to the shared media. ASAs receiving the announce message then determine whether the device is a “discovered” device. If the device is also not acquired, the AA decides whether to authorize the ASA to acquire the discovered device. If authorized, the ASA then assigns an available device ID to the device. The device ID must be unique within the logical network, but does not necessarily have to be globally unique.

One advantage is that the system provides a simple way to segment a shared media into several logical networks. In addition, the system provides an easy-to-use mechanism for connecting devices to a network suitable for the general public.

Exemplary Networked and Distributed Environments

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes, which may be used in connection with computing objects on a shared medium. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

Distributed computing facilitates sharing of computer resources and services by direct exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the discovery, acquisition or maintenance of nodes on a logical network of the invention.

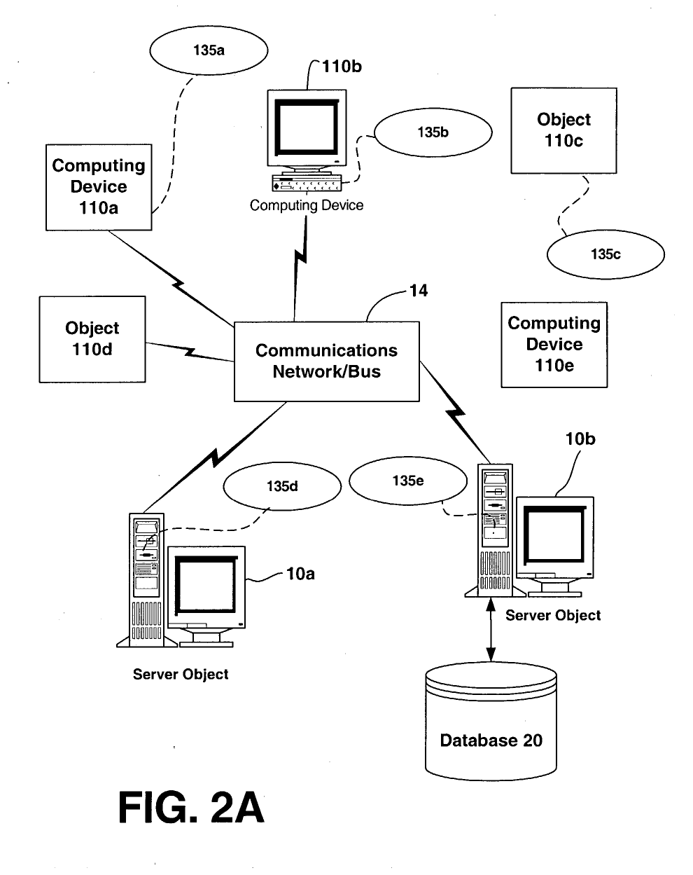

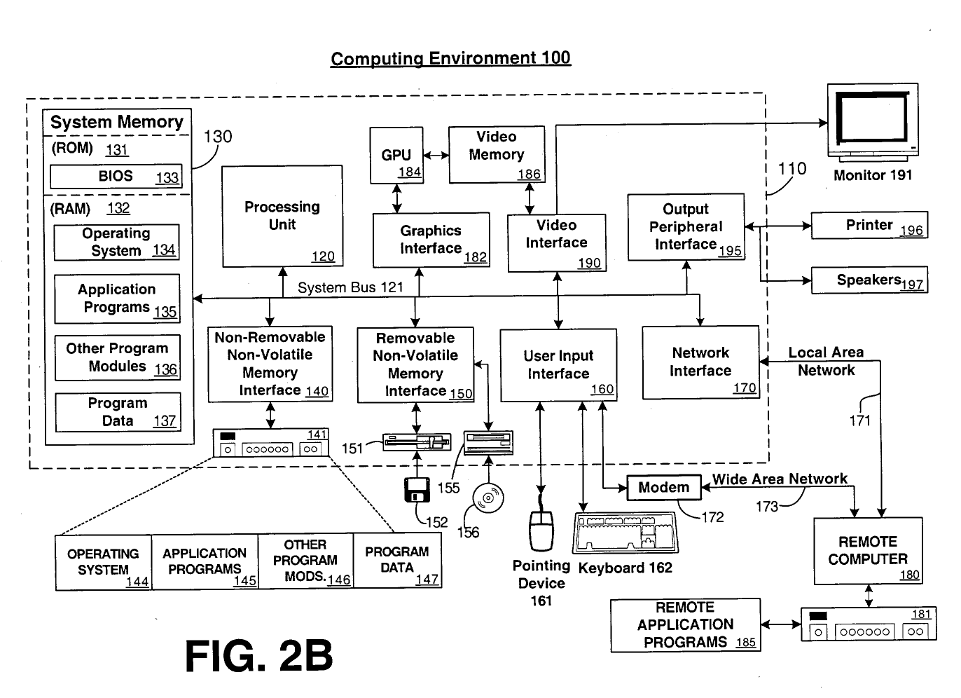

FIG. 2A provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, televisions, MP3 players, televisions, personal computers, etc. Each object can communicate with another object by way of the communications network 14. This network may itself comprise other computing objects and computing devices that provide services to the system of FIG. 2A. In accordance with an aspect of the invention, each object 10a, 10b, etc. or 110a, 110b, 110c, etc. may contain an application that might make use of an API, or other object, software or hardware, to request use of the discovery, acquisition or maintenance services in accordance with the invention.

In a distributed computing architecture, computers, which may have traditionally been used solely as clients, communicate directly among themselves and can act as both clients and servers, assuming whatever role is most efficient for the network. This reduces the load on servers and allows all of the clients to access resources available on other clients, thereby increasing the capability and efficiency of the entire network. Services that use the discovery, acquisition or maintenance techniques in accordance with the present invention may thus be distributed among clients and servers, acting in a way that is efficient for the entire network.

Distributed computing can help businesses deliver services and capabilities more efficiently across diverse geographic boundaries. Moreover, distributed computing can move data closer to the point where data is consumed acting as a network caching mechanism. Distributed computing also allows computing networks to dynamically work together using intelligent agents. Agents reside on peer computers and communicate various kinds of information back and forth. Agents may also initiate tasks on behalf of other peer systems. For instance, intelligent agents can be used to prioritize tasks on a network, change traffic flow, search for files locally or determine anomalous behavior such as a virus and stop it before it affects the network. All sorts of other services may be contemplated as well. Since data may in practice be physically located in one or more locations, the ability to distribute services that use the discovery, acquisition or maintenance techniques described herein is of great utility in such a system.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides the infrastructure for widely distributed computing and encompasses many different networks.

In home networking environments, there are at least four disparate network transport media that may each support a unique protocol, such as Power line, data (both wireless and wired), voice (e.g., telephone) and entertainment media. Most home control devices such as light switches and appliances may use power line for connectivity. Data Services may enter the home as broadband (e.g., either DSL or Cable modem) and are accessible within the home using either wireless (e.g., HomeRF or 802.11b) or wired (e.g., Home PNA, Cat 5, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also used as digital interconnects for clusters of media devices. All of these network environments and others that may emerge as protocol standards may be interconnected to form an intranet that may be connected to the outside world by way of the Internet. In short, a variety of disparate sources exist for the storage and transmission of data, and consequently, moving forward, computing devices will require ways of sharing data, such as data accessed or utilized incident to program objects, which make use of the discovery, acquisition or maintenance techniques in accordance with the present invention.

The Internet commonly refers to the collection of networks and gateways that utilize the TCP/IP suite of protocols, which are well-known in the art of computer networking. TCP/IP is an acronym for “Transport Control Protocol/Internet Protocol.” The Internet can be described as a system of geographically distributed remote computer networks interconnected by computers executing networking protocols that allow users to interact and share information over the networks. Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2A, computers 110a, 110b, etc. can be thought of as clients and computer 10a, 10b, etc. can be thought of as the server where server 10a, 10b, etc. maintains the data that is then replicated in the client computers 110a, 110b, etc., although any computer could be considered a client, a server, or both, depending on the circumstances.

A server is typically a remote computer system accessible over a remote network such as the Internet. The client process may be active in a first computer system, and the server process may be active in a second computer system, communicating with one another over a communications medium, thus providing distributed functionality and allowing multiple clients to take advantage of the information-gathering capabilities of the server.

Client and server communicate with one another utilizing the functionality provided by a protocol layer. For example, Hypertext-Transfer Protocol (HTTP) is a common protocol that is used in conjunction with the World Wide Web (WWW). Typically, a computer network address such as a Universal Resource Locator (URL) or an Internet Protocol (IP) address is used to identify the server or client computers to each other. The network address can be referred to as a URL address. For example, communication can be provided over a communications medium. In particular, the client and server may be coupled to one another via TCP/IP connections for high-capacity communication.

Thus, FIG. 2A illustrates an exemplary networked or distributed environment, with a server in communication with client computers via a network/bus, in which the present invention may be employed. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to implement discovery, acquisition or maintenance of nodes on a logical network.

In a network environment in which the communications network/bus 14 is the Internet, for example, the servers 10a, 10b, etc. can be Web servers with which the clients 110a, 110b, 110c, 110d, 110e, etc. communicate via any of a number of known protocols such as HTTP. Servers 10a, 10b, etc. may also serve as clients 110a, 110b, 11oc, 110d, 110e, etc., as may be characteristic of a distributed computing environment. Communications may be wired or wireless, where appropriate. Client devices 110a, 110b, 110c, 110d, I 10e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 110e, etc. and server computer 10a, 10b, etc. may be equipped with various application program modules or objects 135 and with connections or access to various types of storage elements or objects, across which files may be stored or to which portion(s) of files may be downloaded or migrated. Any computer 10a, 10b, 110a, 110b, etc. may be responsible for the maintenance and updating of a database 20 or other storage element in accordance with the present invention, such as a database or memory 20 for storing data processed according to the invention. Thus, the present invention can be utilized in a computer network environment having client computers I 10a, I 10b,etc. that can access and interact with a computer network/bus 14 and server computers 10a,10b,etc. that may interact with client computers 110a, 110b, etc. and other like devices, and databases 20.

Exemplary Computing Device

FIG. 2B and the following discussion are intended to provide a brief general description of a suitable computing environment in which the invention may be implemented. It should be understood, however, that handheld, portable and other computing devices and computing objects of all kinds are contemplated for use in connection with the present invention. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved is a desirable, or suitable, environment for operation of the techniques for discovering, acquiring and maintaining nodes in a logical network in accordance with the invention.

Although not required, the invention can be implemented via an operating system, for use by a developer of services for a device or object, and/or included within application software that operates in connection with discovering, acquiring and maintaining nodes in a logical network in accordance with the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 2B thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 2B, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2B illustrates operating system 134, application programs 135, other program modules 136, and program data 137.

The computer 110 may also include other removable/non-removable, volatile/nonvolatile computer storage media. By way of example only, FIG. 2B illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2B provide storage of computer readable instructions, data structures, program modules and other data for the computer 110. In FIG. 2B, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186, wherein the application variables of the invention may have impact. GPUs 184, however, are but one example of a coprocessor and thus a variety of coprocessing devices may be included in computer 110, and may include a variety of procedural shaders, such as pixel and vertex shaders. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2B. The logical connections depicted in FIG. 2B include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a smodem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2B illustrates remote application programs 185 as residing on memory device 181. It will be appreciated that the network connections shown are exemplary and other means of establishing a communications link between the computers may be used.

Exemplary Distributed Computing Frameworks or Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET platform includes servers, building-block services, such as Web-based data storage and downloadable device software. Generally speaking, the NET platform provides (1) the ability to make the entire range of computing devices work together and to have user information automatically updated and synchronized on all of them, (2) increased interactive capability for Web sites, enabled by greater use of XML rather than HTML, (3) online services that feature customized access and delivery of products and services to the user from a central starting point for the management of various applications, such as e-mail, for example, or software, such as Office NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform integration features as well.

As part of the .NET Framework, the Common Language Runtime (CLR) is a managed execution environment with programming that manages the execution of programs written in any of several supported languages, allowing them to share common object-oriented classes written in any of the languages. A program compiled for the CLR does not need a language-specific execution environment and can easily be moved to and run on any system. Thus, for example, programmers writing in any of Visual Basic, Visual C++, C#, etc. can compile their programs into an intermediate form of code called Common Intermediate Language (CIL) in a portable execution (PE) file that can then be managed and executed by the CLR. The programmer and the environment specify descriptive information about the program when it is compiled and the information is stored with the compiled program as metadata. Metadata, stored in the compiled program, tells the CLR what language was used, its version, and what class libraries will be needed by the program. Thus, for instance, the CLR allows an instance of a class written in one language to call a method of a class written in another language.

While some exemplary embodiments herein are described in connection with software residing on a computing device, one or more portions of the invention may also be implemented via an operating system, application programming interface (API) or a “middle man” object, a control object, hardware, firmware, etc., such that the methods may be included in, supported in or accessed via all of NET's languages and services, and in other distributed computing frameworks as well.

Systems and Methods for Discovery, Acquisition and Maintenance

As mentioned, the ASA of the invention achieves improvements and optimizations for devices and objects on a networked shared medium in at least the following three areas: discovery, acquisition and maintenance. The ASA provides management of the discovery, acquisition and maintenance of nodes in a logical network on top of a shared physical medium to provide a secure public network of interconnected devices and objects.

Discovery

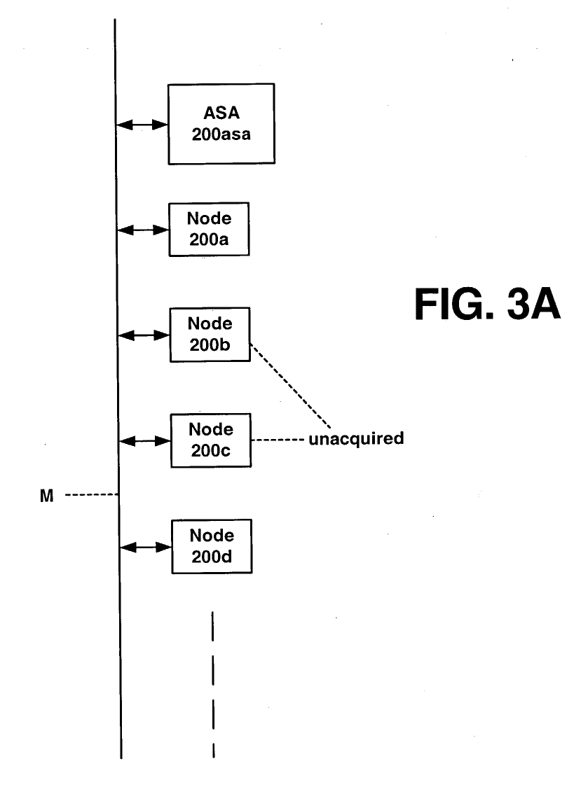

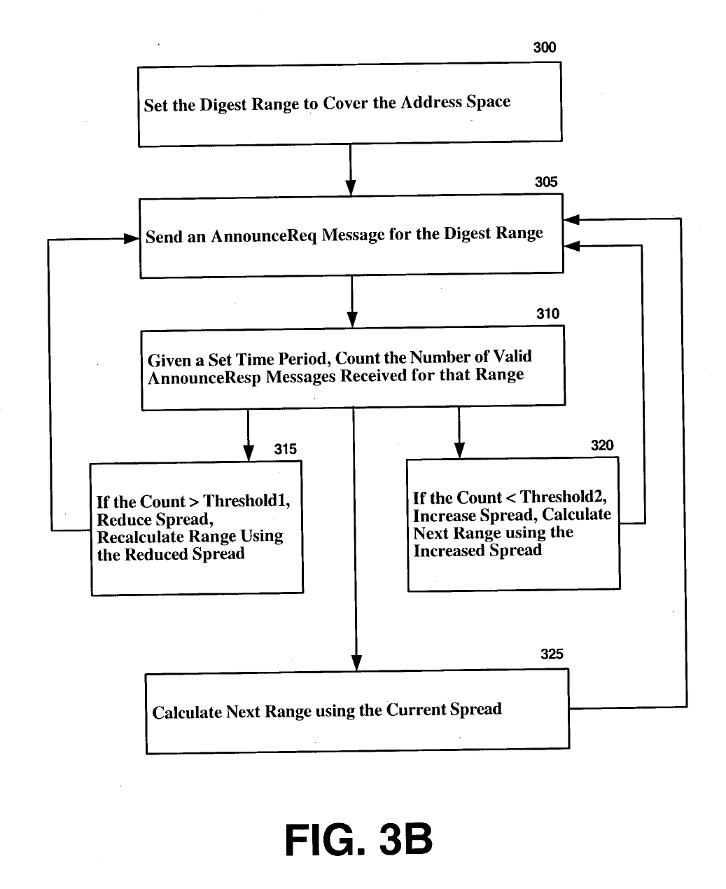

In the exemplary network scenario of FIG. 3A, with a variety of devices sharing a public medium M, some of the nodes or devices, such as node b and node c may not be “acquired” into the logical network yet. This is achieved by discovering their yet unknown device serial numbers (DSNs). With respect to discovery, the invention utilizes two messages, i.e., AnnounceReq and AnnounceResp messages, as a means for discovering devices on a physical network, such as an SCP physical network. In this regard, discovery of new devices can be initiated by the ASA either on a periodic basis (polling) or initiated by the acquisition authority (e.g., because a new device is plugged in).

For that purpose, the ASA uses the AnnounceReq message targeting un-acquired devices using a range of DSN digests, e.g., 16-bit DSN digests. Since a DSN may be quite a large number, and because the hash of the DSN is highly likely also to be unique, network bandwidth can be saved by communicating a hash of the DSNs. Since the ASA has no a priori knowledge of how many devices may respond, the ASA may use the exemplary approach of FIG. 3B.

In FIG. 3B, the process begins at 300 by setting the digests range to cover the whole address space. For 16 bits, this would mean for digests 0 to 65535 (a spread of 65536). Next, an AnnounceReq is sent for the range at 305. Next, at 310, for a pre-set time period p, the number of valid AnnounceResp received for that range is counted. In this regard,-a data link backoff with time out mechanism is relevant in counting the number of replies because after a preset period, it is assumed that no more replies are forthcoming.

If the count is greater than a threshold c1, at 315, the spread is reduced and the range is recalculated using the new spread, and the process is repeated from the sending of the AnnounceReq. If the count is less than a threshold c2, at 320, the spread is increased and the next range is calculated using the new spread, and the process is repeated from the sending of the AnnounceReq. Otherwise, the next range is calculated at 325 using the current spread, and the process is repeated from the sending of the AnnounceReq.

For purposes of setting thresholds, p is calculated to be greater than the time of the maximum data link backoff timeout+the transmission time for the AnnounceResp message, c1 is calculated to be greater than 1 and less than the maximum number of AnnounceResp messages that can physically be transmitted in p time and c2 is calculated to be less than the minimum number of AnnounceResp messages that can physically be transmitted in p time.

During this first discovery step, information collected for each device includes the device serial number (DSN), acquisition nonce (i.e., a cryptographic term referring to an incremented number used in the encryption key to prevent using the same key twice, and to thwart replay attacks), membership lease and presence lease. The term nonce generally refers to an encryption nonce, but is referred to here as an acquisition nonce because it is in the context of acquiring devices/nodes into the logical network.

Upon enumeration of all un-acquired devices, the ASA and/or the acquisition authority may optionally initiate another process to retrieve human-readable information about each device, e.g., “table lamp” or “flat screen TV” to provide additional information about the device being acquired.

For that purpose, the ASA uses the AnnounceReq message targeting a specific device by its DSN and requests description data for a set of well known root device descriptor IDs. The retrieval of each descriptor may be segmented in multiple AnnounceReq/AnnounceResp exchanges at incrementing offsets when only a limited amount of data can fit in each message.

The ASA may use this data, as well as data obtained by a web-based service to present meaningful information about this device to the acquisition authority.

Discovery of already acquired devices, for the purpose of recovering information about an already formed logical network, follows the steps of FIG. 3B as outlined above, except that the AnnounceReq messages target a specific logical network ID and a range of node IDs for that network (i.e., the address space covers the lowest possible node ID to the highest possible node ID allowable for the type of physical network). The retrieval of information about each device follows the same process as outlined above.

Exemplary non-limiting functionality/pseudo code for the AnnounceResp message in accordance with the invention is as follows. With respect to an AnnounceReq Message, the Address Space Arbitrator (ASA) sends the AnnounceReq message to trigger an AnnounceResp message on the part of one or more targeted devices. The AnnounceReq message includes the following data fields.

| Data field | Octets |
|---|---|
| NCP_AnnReqNetworkId | 2 |
| NCP_AnnReqAddrMode | 2 bits |
| NCP_AnnReqType | 2 bits |
| NCP_AnnReqSrcNode ID | 1.5 |
| NCP_AnnReqTargetAddr | Variable |
| NCP_AnnReqTargetRequest | Variable |

NCP_AnnReqNetworkld identifies the logical network to which the requesting node belongs. NCP_AnnReqAddrMode specifies the address mode. This field allows the one or more devices to be targeted. It is used as a discriminator to interpret the format of the NCP_AnnReqTargetAddr field. The mode can have one of the following values.

| Value | Description |
|---|---|
| 0 | Targets a single device identified by its device serial number (DSN). The |
| | NCP_AnnReqTargetAddr field will specify the 16-octet target DSN. |
| 1 | Targets one or more devices, which are not members of any logical network, identified |
| | by DSN digest. The NCP_AnnReqTargetAddr field specifies the low and high end of a |
| | range of DSN digests. All devices whose DSN digests fall within the range will respond |
| | to the AnnounceReq message. The low and high DSN digests should be in the range 0 |
| | to 65,535. |
| 2 | Targets one or more devices which are members of the network specified by |
| | NCP_AnnReqNetworkId. The NCP_AnnReqTargetAddr field specifies the low and |
| | high end of a range of node IDs. All devices whose node IDs fall within the range will |
| | respond to the AnnounceReq message. The low and high node IDs should be in the |
| | range 0 to 4095. |
| 3 | Targets any device that is a member of the logical network identified by |
| | NCP_AnnReqNetworkId. This mode is used to test whether the network ID is being |
| | used. |
| | When this mode is specified, the NCP_AnnReqType field is ignored and the |
| | NCP_AnnReqTargetAddr and NCP_AnnReqTargetRequest fields are empty. |

NCP_AnnReqType specifies the type of response requested. The value of this field indicates the type of data being requesting from the targeted nodes.

| Value | Description |
|---|---|
| 0 | Requesting NCP variables from the targeted nodes. |
| 1 | Requesting a root device descriptor string from the targeted nodes. |
| 2, 3 | Not used. These values are reserved for future use. |

NCP_AnnReqSrcNode ID identifies the requesting node. NCP_AnnReqTargetAddr specifies the address of the target nodes. This field is dependant on the value of the NCP_AnnReqAddrMode field. NCP_AnnReqTargetRequest describes the format of the requested data. The format depends on the NCP_AnnReqType field. This field is meaningful when a root device descriptor string is requested (a request type of value 1). The NCP_AnnReqTargetRequest field includes the following data items.

| Item | Description | Octets |
|---|---|---|
| NCP_RootDevDescrId | Root device descriptor ID. | 0.5 |
| NCP_RootDevDescrStrOffset | Offset of the first byte in the | 1.5 |
| | string to be returned. This allows | |
| | a large description string | |
| | to be read in multiple announce | |
| | messages. | |
| NCP_PreferredLangId | Preferred language identifier | 2 |
| | (LANGID). | |

Exemplary non-limiting functionality/pseudo code for the AnnounceResp message in accordance with the invention is as follows. A device sends the AnnounceResp message in response to an AnnounceReq message. The AnnounceResp message includes the following data fields.

| Data field | Octets |
|---|---|
| NCP_AnnReqNetworkId | 2 |
| NCP_AnnReqAddrMode | 2 bits |
| NCP_AnnReqType | 2 bits |
| NCP_AnnReqSrcNode ID | 1.5 |
| NCP_AnnounceData | Variable |

NCP_AnnReqNetworkld identifies the requesting node's network. NCP_AnnReqAddrMode specifies the addressing mode. NCP_AnnReqType specifies the type of response that's requested. NCP_AnnReqSrcNode ID identifies the requesting node.

NCP_AnnounceData specifies the actual response data.

A device sends the AnnounceResp message in response to a qualifying AnnounceReq message. This message is encrypted. In one embodiment, the first four octets of this message (fields with names starting with NCP_AnnReq . . . ) are identical to the contents of the invoking AnnounceReq message and are used to match the announcement with the invitation. The second part of this message (NCP_AnnRespData) includes the content of the response.

The network ID test request (NCP_AnnReqAddrMode has a value of 3) is targeted to any node that is a member of the logical network, and at least one member node responds. This is accomplished by each node waiting before sending the response by a value which is a hash of its node ID up to 5000 milliseconds. However, a time master and the Address Space Arbitrator (ASA) managing this network respond immediately. The first response cancels the request for all other nodes, with the exception of the ASA which responds to indicate to the requester that the logical network is being managed. This prevents two ASAs from attempting to manage the same logical network.

In the case of a network test response, NCP_AnnReqSrcNode ID is actually the node ID of the node generating the reply, and NCP_AnnounceData is always empty (0 octets).

If the Network Control Protocol (NCP) variables request (NCP_AnnReqType) has a value of 0, it causes any qualifying node to reply with the following information.

| AnnounceData | Description | Octets |
|---|---|---|
| NCP_AnnoDSN | Announcer's device serial | 16 |
| | number (DSN) | |
| NCP_AnnoNode ID | Announcer's node ID | 2 |
| NCP_AnnoProtoVer | Protocol version number | 1 |
| NCP_AnnoFirmwareVer | Firmware version number | 1 |
| NCP_AnnoNonce | Acquisition nonce value | 2 |
| NCP_AnnoMembershipLease | Membership lease value | 2 |
| NCP_AnnoPresenceLease | Presence lease value | 2 |

The NCP_AnnoNonce is a 16-bit unsigned counter incremented every time the device accepts a secure NetAssign . . . or a NetKeyAssign message, it is intended to prevent a replay of these messages. The value of the counter is persisted for the lifetime of the device.

The membership and presence leases are advisory values for the time outs (expressed in seconds), as specified by the device manufacturer.

Acquisition

With respect to acquisition, at the request of the acquisition authority, and using information obtained during discovery as well as information provided by the acquisition authority, the ASA assigns a node ID to the device and acquires it in the logical network.

After discovery, for discovered devices, the ASA includes the following information: a DSN (digests), a POK, a nonce, a presence lease and membership lease. The acquisition problem is as follows: given a device presence lease, assign a node ID without any a priori knowledge of the rest of device characteristics. In this regard, devices can be assigned to various positions in the node ID addressing space, e.g., either as fast presence refresh devices or slow presence refresh devices. The '370 application, entitled “Systems and Methods for Providing Presence Tracking in a Distributed Computing System” includes more detail about fast and slow presence refresh devices. Optimally, assigning node IDs to devices would first include a view of the characteristics for all devices on the network; however, this is not situation. The invention thus optimizes the position of the node ID in node ID space.

In order to acquire a device, the acquisition authority identifies it by its DSN, and provides its Private Ownership Key (POK), e.g., a 128-bit encryption key. An alternative method to providing a POK is to provide a Device Acquisition Key (DAK), which is a more user-friendly number, e.g., a number including 35 alphanumeric characters. In addition to the POK, the DAK can also include the device's DSN digest (as a way to verify that the DSN-POK pair is valid) and a 16-bit check code (as a way to verify that the DAK provided, or entered by the user, is valid).

Restating the acquisition problem for the ASA, the goal is for the ASA to assign a node ID to a targeted device provided that it has no a priori knowledge of which devices may be acquired (in the future), it tries to keep the device's presence leases ordered by node ID, there cannot be two devices with the same node ID and each device's presence time out must be less than its presence lease.

To achieve this goal, in accordance with the invention, the ASA compares the targeted device's presence lease to the slow presence time out for the logical network (the value of the AP variable eScpAPVars_Net_PresenceSlowTimeout). If less, the ASA picks the lower range of node IDs (up to but not including eScpAPVars_Net_PresenceSlowBaseld). If greater or equal, the ASA picks the upper range of node IDs (from eScpAPVars_Net_PresenceSlowBaseld up). See, e.g., the '457 and '370 applications for additional description regarding AP variables and the division of node ID address space into fast and slow presence devices.

The ASA then attempts to reduce the range of free node IDs (node IDs which have not been assigned to other devices) between the first node of lesser or equal presence lease and the first node of greater presence lease after that. Once the “free” range has been established, it then chooses a node ID calculated such that its ratio in the range is the ratio of the device's presence lease per the range of presence leases.

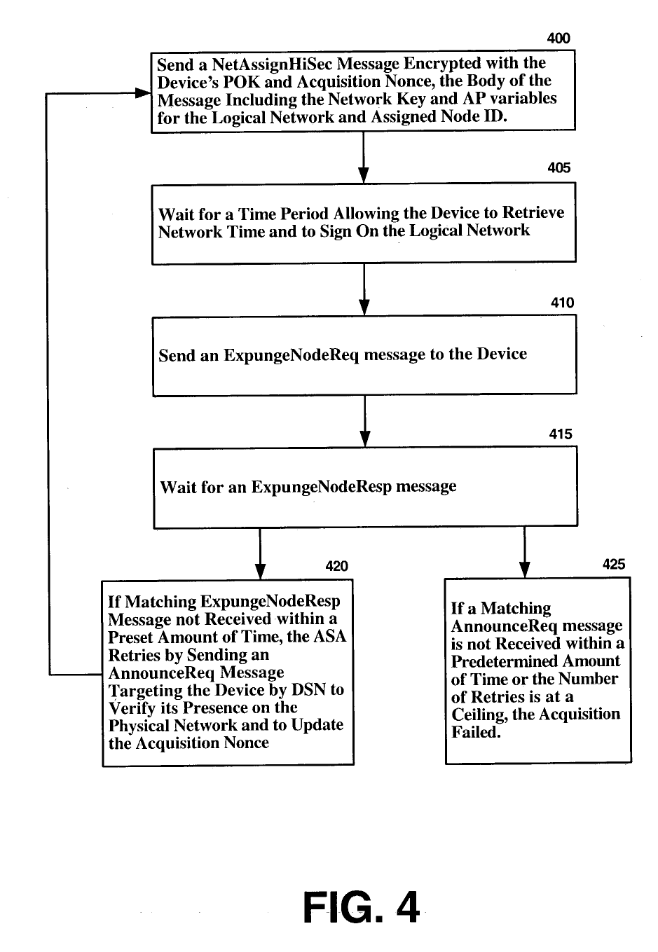

Given a targeted device and knowing its DSN, POK, acquisition nonce and assigned node ID, the ASA acquires it in the logical network by using the approach illustrated in FIG. 4.

At 400, the ASA sends a NetAssignHiSec message encrypted with the device's POK and acquisition nonce, the body of the message containing the network key and AP variables for the logical network as well as its assigned node ID. At 405, a wait occurs for a time period allowing the device to retrieve the network time, and sign on the logical network. At 410, an ExpungeNodeReq message is sent to the device. In this regard, 4095, for example, can be used as the ID to expunge, which effectively uses the expunge node mechanism as a ping. At 415, the ASA waits for an ExpungeNodeResp message. At 420, if a matching ExpungeNodeResp message is not received within a predetermined amount of time, the ASA retries the process at 400 by sending an AnnounceReq message targeting the device by its DSN to verify its presence on the physical network and to update the acquisition nonce. Alternatively, at 425, if a matching AnnounceReq message is not received within a predetermined amount of time or the number of retries is at a ceiling, the acquisition is considered to have failed.

Exemplary, non-limiting implementations of the NetAssignHiSec message, ExpungeNodeReq message and ExpungeNodeResp message follow:

With respect to the NetAssignHiSec message, the ASA sends the message to assign or remove a target device's membership in a logical network that is operating in high security mode.

The NetAssignHiSec message includes the following exemplary data fields:

| Data field | Octets |
|---|---|
| NCP_TargetDSNDigest | 2 |
| NCP_NetId | 2 |
| NCP_NodeId | 2 |
| NCP_NetKey | 16 |
| NCP_APVars | Up to 42 |
| NCP_MAC | 4 |

The NCP_TargetDSNDigest data field specifies the device serial number (DSN) digest of the target node. The NCP_NetId data field identifies the assigned network. The NCP_NodeId data field identifies the assigned node. The NCP_NetKey data field specifies the network key. The NCP_APVars data field includes the Application Protocol (AP) variables. The NCP_MAC data field specifies the message authentication code (MAC) which applies to the Network Control Protocol (NCP) message type and each of the previous fields.

In one embodiment, the ASA encrypts the NetAssignHiSec message using the target's private ownership key (POK) and current NCP_AnnoNonce (obtained from an announce reply message). This encryption also performs the function of addressing the target device, since only it is able to decrypt the message. The ASA includes the DSN digest as a check on the target identity. To indicate that the device should leave the network, the NCP_NodeId element can be set to 0×0FFF.

With respect to the ExpungeNodeReq message, the ASA sends the message to request a set of member nodes to remove a node ID from their routes. The ASA may issue this message to recycle a node ID after removing a node from the logical network.

The ExpungeNodeReq message includes the following exemplary data fields:

| Data field | Octets |
|---|---|
| NCP_ReqDeletedNodeId | 1.5 |
| NCP_ReqTargetNodeIdLow | 1.5 |
| NCP_ReqTargetNodeIdHigh | 2 |

The NCP_ReqDeletedNodeId data field identifies the node to be removed. The NCP_ReqTargetNodeIdLow data field identifies the target node at the low end of the range. The NCP_ReqTargetNodeIdHigh data field identifies the target node at the high end of the range.

In one embodiment, each member device targeted by this message attempts to remove the node from its tables and issues an ExpungeNodeResp message if successful.

Both ExpungeNodeReq and ExpungeNodeResp are tunneled through the Application Protocol (AP). Devices that have node IDs that fall within the range specified by the NCP_ReqTargetNodeIdLow and NCP_ReqTargetNodeIdfligh data fields process the ExpungeNodeReq message. An NCP_ReqDeletedNodeId value of 0 (broadcast) specifies that all routes and subscriptions should be deleted from the target device(s) tables. A value of 0×0FFF acts as a ping, whereby the target device(s) should not modify their tables but reply with an ExpungeNodeResp message.

With respect to an ExpungeNodeResp message, a device sends an ExpungeNodeReq message in response to a qualifying ExpungeNodeReq message, if the removal was successful.

The ExpungeNodeReq message includes the following exemplary data fields:

| Data field | Octets |
|---|---|
| NCP_ReqDeletedNodeId | 1.5 |
| NCP_ReplyingNodeId | 1.5 |

The NCP_ReqDeletedNodeId data field identifies the node from the ExpungeNodeReq message. The NCP_ReplyingNodeId data field identifies the node issuing the response.

In one embodiment, both ExpungeNodeReq and ExpungeNodeResp are tunneled through the Application Protocol (AP). If NCP_ReqDeletedNodeId is 0×0FFF, the node replies without modifying its routes and subscriptions.

Maintenance

The logical network maintenance provided by the ASA covers renewing the logical network key and optimizing the AP variables given the physical network conditions. AP messages are targeted for a node using the network ID, the source node ID, the destination node ID and the network time, using encrypted communications, such as RC4, including the nonce. It is to be understood that while RC4 can be used for encrypted communications, RC4 does not specify the encryption key, but rather the logical network, such as SCP, specifies the encryption key.

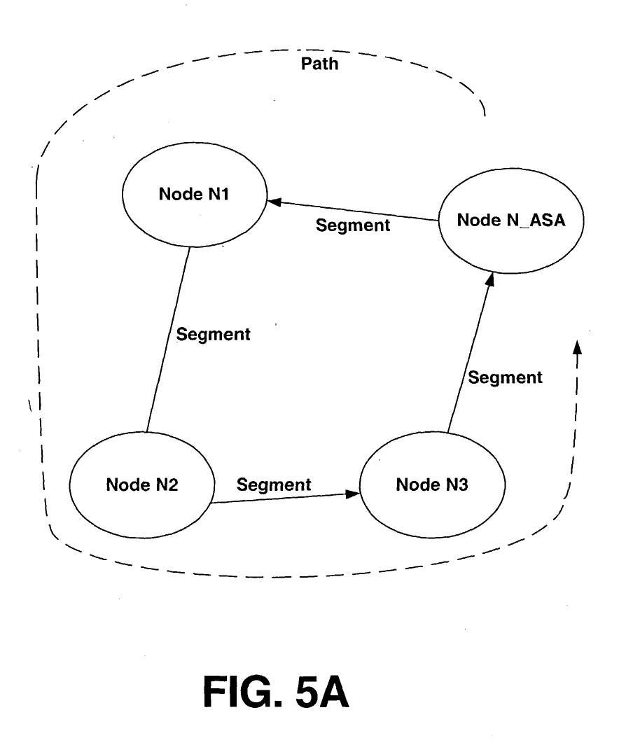

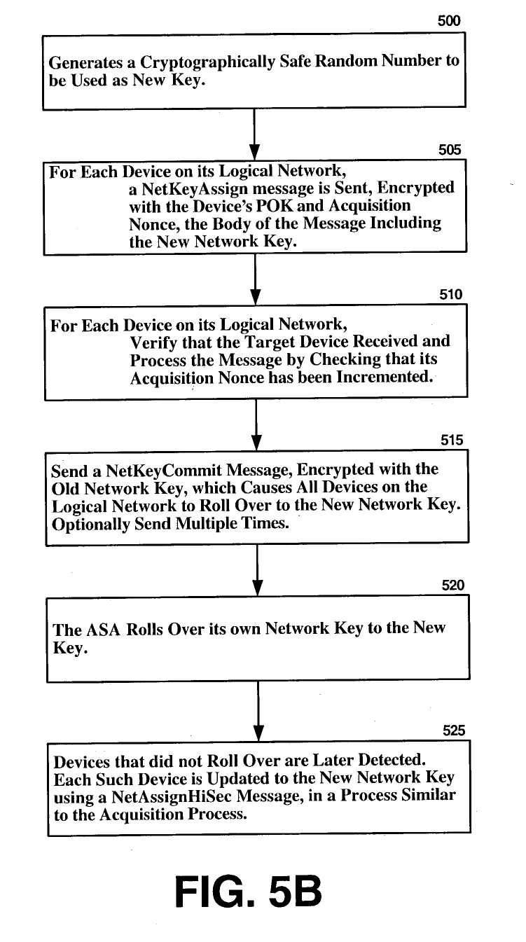

Given that a 32-bit millisecond counter is used in the RC4 encryption key as a nonce, and to protect the confidentiality of the messages payload (given that this counter will wrap around approximately every 49 days), it is necessary for the ASA to change the network key at regular time intervals (shorter that 49 days). This involves rolling over the old network key to the new network key. To achieve this, as illustrated in FIG. 5B, at 500, the ASA generates a cryptographically safe random number (e.g., 128-bits) to be used as the new key. Then, at 505, for each device on its logical network, the ASA sends a NetKeyAssign message encrypted with the device's POK and acquisition nonce, with the body of the message including the new network key. At 510, for each device on its logical network, the ASA verifies that the target device did receive and process the message by checking that its acquisition nonce has been incremented, e.g., using an AnnounceReq/AnnounceResp exchange. At 515, the ASA sends a NetKeyCommit message, encrypted with the old network key which causes all devices on the logical network to roll over to the new network key. This message may be sent multiple times depending on the network conditions to improve the chances that all devices receive it. At 520, the ASA rolls over its own network key to the new key. At 525, devices which did not roll over (possibly because they were not online at the time of the key change) are later detected because their messages are coming through as unauthentic, i.e., encrypted with the wrong network key. Each detected device is updated to the new network key using a NetAssignHiSec message, in a process similar to the acquisition process.

An exemplary, non-limiting implementation the NetKeyCommit message follows:

With respect to the NetKeyCommit message, in a logical network that is operating in high security mode, an ASA sends the NetKeyCommit message to force all devices on its logical network to use a new network key that was previously sent to individual nodes by using the NetKeyAssign message.

The NetKeyCommit message includes the following exemplary data fields:

| Data field | Octets |
|---|---|
| NCP_NetTime | 4 |
| NCP_SrcNodeId | 2 |
| NCP_MAC | 4 |

The NCP_NetTime data field specifies the network time in milliseconds. This value is not encrypted. The NCP_SrcNodeId data field identifies the sending node. The NCP_MAC data field specifies the message authentication code (MAC) which applies to the Network Control Protocol (NCP) message type and each of the previous fields.

In one embodiment, SCP uses the network ID, network time and network key to encrypt the NetKeyCommit message. The sender's network time is sent unencrypted for the purpose of decryption. The receiving devices check NCP_NetTime against the time master's network time and ignore the message if not within the allowable offset; this is intended to protect against replay attacks. The NetKeyCommit message has no effect unless a NetKeyAssign message was previously received.

To lower network traffic due to a large number of nodes on the logical network, the ASA can optimize new presence AP variables (by increasing eScpAPVars_Net_PresenceFastRefresh and eScpAPVars_Net_PresenceSlowRefresh) such that the total traffic generated by presence keep alives is lower (assuming an otherwise idle network). The slow and fast time outs are also increased accordingly, and eScpAPVars_Net_PresenceSlowBaseld is adjusted such that it corresponds to the first node with a presence lease of equal or greater value (given that the node IDs are sorted by increasing PresenceLease by the node ID assignment logic). For more details regarding application variables, keep alives and presence tracking, see the '457 and '370 applications.

FIG. 5A illustrates an exemplary implementation of the invention that determines path qualities through logical node test path operation, which can be used in connection with tuning AP variables to implement a maintenance process of the invention. The ASA node sends messages through various combinations and permutations of nodes N1, N2, N3, etc. and makes determinations and/or cross-correlations with respect to which node paths are good and which node paths are of poor quality. In this regard, each node knows whether or not it receives a message, and the signal quality for the segment. A chart can be built in accordance with such a procedure that describes the point to point segment quality between any two nodes. With reference to the chart, network conditions can be optimized for any two node point communications, and such test path operation can be dynamically updated in accordance with current network conditions. The rate of network traffic for each node can also be taken into account in accordance with the invention. A distinction can also be made with respect to noise correction where the correct data is difficult to decipher vs. error correction where the data is incorrect. This chart can be saved in the ASA, and is a part of the maintenance process in accordance with the invention.

Thus, to correct adverse node-specific transmission conditions, the ASA can use the TestPath above to retrieve information about weak transmitter nodes and optimize datalink-related transmission AP variables (eScpAPVars_DLL_BlockedTimeoutMs, eScpAPVars_DLL_BroadcastBurstCount and eScpAPVars_DLL_MaxAckAttempts).

In accordance with the invention, AP variables updates are distributed to the whole logical network by the ASA as follows. The ASA segments the address space in groups of consecutive node IDs such that each group of one or more nodes (a) has the same AP variables values and (b) includes at most n nodes. Then, for each group of nodes, the ASA sends a WriteVarsReq message targeting that group, with a payload that includes the updated AP variables values for that group. After the request, the ASA waits for either all qualifying WriteVarsResp messages to come back or waits for a time out period p to expire. The ASA may retry the transaction for the nodes which did not respond i.e., for the nodes for which a correct WriteVarsResp was not received.

In one embodiment, n is calculated to be less that the theoretical maximum number of response messages that can be sent back given the message transmission time and the data link blocked time out. p is calculated to be greater than the transmission time for the response message times the number of nodes in the group.

Exemplary, non-limiting implementations of the WriteVarsReq message, and WriteVarsResp message follow:

With respect to the WriteVarsReq message, the ASA sends the message to request that the targeted node updates its protocol variables to the values passed in the message.

The WriteVarsReq message includes the following exemplary data fields:

| Data field | Octets |
|---|---|
| NCP_NetTime | 4 |
| NCP_ReqVarsRequested | 0.5 |
| NCP_ReqTargetNodeId | 1.5 |
| NCP_ReqCount | 2 |
| NCP_VarsValues | Up to 64 |
| NCP_MAC | 4 |

The NCP_NetTime data field specifies the network time in milliseconds. This value is not encrypted. The NCP_ReqVarsRequested data field includes the requested protocol variables. The NCP_ReqTargetNodeId data field identifies the target node. The NCP_ReqCount data field specifies the request counter value. This value is specified in the corresponding response message. The NCP_VarsValues data field includes the protocol variables value-stream. The NCP_MAC data field specifies the message authentication code (MAC) which applies to the NCP message type and each of the previous fields.

In one embodiment, each targeted node replies with a WriteVarsResp message upon successfully updating its variables. This message may be broadcast such that all nodes on the logical network are targeted at once. The NCP_ReqVarsRequested field is 0, 1, or 2 since only AP variables and Data Link configuration variables can be written.

To allow correlation between requests and responses, the NCP_ReqCount parameter is a value the device should return in the corresponding WriteVarsResp message. The NCP_VarsValues field includes a header followed by the actual variables. Each 2-bit value in the header specifies the size of the corresponding protocol variable. The following table lists the possible values of each 2-bit value and that value's significance.

| Value | Significance |
|---|---|
| 1 | Corresponding variable is 4-bits in length. |
| 2 | Corresponding variable is 1 byte in length. |
| 3 | Corresponding variable is 2 bytes in length. |
| 0 | Identifies end of header. (Subsequent bits contain |
| | actual variable data.) |

For example, if the NCP_VarsValues field is 0×56C0ABCDEF023, there would be a total of five variables in the stream with decimal values of: 10, 11, 12, 222, and 61,475, respectively.

If the requesting device does not receive a response within a media-specific period of time, the requesting device missed the response or the targeted device did not receive the request. In this case, the requesting device should make a media-specific number of retry attempts prior to assuming an error situation exists.

With respect to the WriteVarsResp message, a device sends the WriteVarsResp message in response to a WriteVarsReq message that it receives.

The WriteVarsResp message includes the following exemplary data fields:

| Data field | Octets |
|---|---|
| NCP_NetTime | 4 |
| NCP_ReqVarsRequested | 0.5 |
| NCP_ReplyingNodeId | 1.5 |
| NCP_ReqCount | 2 |
| NCP_MAC | 4 |

The NCP_NetTime data field specifies the network time in milliseconds. This value is sent unencrypted. The NCP_ReqVarsRequested data field includes the requested protocol variables. The NCP_ReplyingNodeId data field identifies the target node. The NCP_ReqCount data field specifies the request counter value. This value is specified in the corresponding request message. The NCP_MAC data field specifies the message authentication code (MAC) which applies to the Network Control Protocol (NCP) message type and each of the previous fields.

In one embodiment, when the request message is broadcast, replying nodes back off their reply up to the values specified by the NCPT×HoldoffDelay variable.

There are multiple ways of implementing the present invention, e.g., an appropriate API, tool kit, driver code, operating system, control, standalone or downloadable software object, etc. which enables applications and services to use the discovering, acquiring and maintaining methods of the invention. The invention contemplates the use of the invention from the standpoint of an API (or other software object), as well as from a software or hardware object that communicates in connection with data generated or used incident to the discovering, acquiring and/or maintaining nodes in a logical network. Thus, various implementations of the invention described herein may have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system in which it is desirable to discover, acquire and maintain nodes in a logical network. For instance, the algorithm(s) and hardware implementations of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the discovery, acquisition and maintenance techniques of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for discovering at least one computing object by an address space arbitrator (ASA) object in communication with an acquisition authority object (and/or person) in a logical network on a public medium, comprising:
discovering at least a serial number for the computing object including:
sending at least one request message; and
receiving at least one response message in response to said at least one request message,
wherein said discovering is one of (A) initiated by the ASA object on a periodic basis and (B) initiated by the acquisition authority object when a computing object of the at least one computing object is instantiated on the public medium.

2. A method according to claim 1, wherein said sending at least one request message includes targeting un-acquired computing objects using a range of device serial number digests.

3. A method according to claim 2, wherein said targeting includes:
setting a range of device serial number digests to cover the whole address space allocated by the ASA;
sending a request message for each address in the range; and
counting the number of valid response messages received for the range.

4. A method according to claim 3, wherein said counting occurs only for a pre-set time period before it is assumed that no more replies are forthcoming.

5. A method according to claim 3, wherein the whole address space includes a range of serial number digests.

6. A method according to claim 3, further including:
if the count is greater than a first threshold, reducing the spread of the range;
recalculating the endpoints of the range using the reduced spread; and
repeating said sending of the request message for each address in the range.

7. A method according to claim 3, further including:
If the count is less than a second threshold, increasing the spread of the range;
recalculating the endpoints of the range using the increased spread; and
repeating said sending of the request message for each address in the range.

8. A method according to claim 4, wherein the pre-set period of time is calculated to be greater than the time of a data link backoff mechanism with timeout that determines when to stop waiting for a response message plus the transmission time for a response message.

9. A method according to claim 6, wherein said counting occurs only for a pre-set time period before it is assumed that no more replies are forthcoming and wherein the first threshold is calculated to be greater than one and less than the maximum number of response messages that can physically be transmitted in the pre-set period of time.

10. A method according to claim 7, wherein said counting occurs only for a pre-set time period before it is assumed that no more replies are forthcoming and wherein the second threshold is calculated to be less than the minimum number of response messages that can physically be transmitted in the pre-set period of time.

11. A method according to claim 1, wherein said discovering includes, for each of the at least one computing objects, discovering the serial number of the computing object, an encryption nonce, a membership lease and a presence lease.

12. A method according to claim 1, further including, after said discovering, retrieving human-readable information about each of the at least one computing device to provide additional information about the object being acquired.

13. A method according to claim 1, wherein when said discovering includes discovering already acquired devices on the logical network, in place of said setting the range of device serial number digests to cover the whole address space allocated by the ASA, said setting includes, for the type of physical network, setting the range from the lowest existing address for an object to the highest existing address for an object.

14. At least one of an operating system, driver code, an application programming interface, a tool kit and a processing device for providing the method of discovering of claim 1.

15. A modulated data signal carrying computer executable instructions for performing the method of claim 1.

16. A computing device comprising means for performing the method of claim 1.

17. An address space arbitrator (ASA) object for the management of a logical network and for keeping a logical network secure, even though the underlying physical network is a shared media, comprising:
a discovery component that discovers at least one serial number for at least one computing object in the logical network by sending at least one request message and receiving at least one response message in response to said at least one request message,
wherein said discovering is one of initiated by the ASA object on a periodic basis and initiated by an acquisition authority object when a computing object of the at least one computing object is instantiated on the public medium.

18. An ASA object according to claim 17, wherein said discovery component targets a range of device serial number digests to cover the whole address space allocated by the ASA, sends a request message for each address in the range and counts the number of valid response messages received for the range.

19. An ASA object according to claim 18, wherein said counting occurs only for a pre-set time period before it is assumed that no more replies are forthcoming, wherein the pre-set period of time is calculated to be greater than the time of a data link backoff mechanism that determines when to stop waiting for a response message plus the transmission time for a response message.

20. An ASA object according to claim 18, wherein if the count is greater than a first threshold, the discovery component reduces the spread of the range, recalculates the endpoints of the range using the reduced spread and repeats said sending of a request message for each address in the range, wherein the first threshold is calculated to be greater than one and less than the maximum number of response messages that can physically be transmitted in the pre-set period of time.

21. An ASA object according to claim 18, wherein if the count is less than a second threshold, the discovery component increases the spread of the range, recalculates the endpoints of the range using the increased spread and repeats said sending of a request message for each address in the range, wherein the second threshold is calculated to be less than the minimum number of response messages that can physically be transmitted in the pre-set period of time.

22. An ASA object according to claim 17, w herein said discovery component collects, for each of the at least one computing objects, information including the serial number of the computing object, an encryption nonce, a membership lease and a presence lease.

23. An ASA object according to claim 17, wherein said discovery component optionally retrieves human-readable information about each of the at least one computing device.

24. An ASA object according to claim 17, wherein when said discovery component is used to discover already acquired devices on the logical network, in place of setting the range of device serial number digests to cover the whole address space allocated by the ASA, setting includes, for the type of physical network, setting the range from the lowest address for an existing object to the highest address for an existing object.

25. A method for acquiring at least one computing object by an address space arbitrator (ASA) object communicatively coupled to an acquisition authority object in a logical network on a public medium, comprising:
at the request of the acquisition authority object, assigning a node identification (ID) to a computing object of the at least one computing object by sending at least one request message utilizing information collected by the ASA object in a discovery process and information provided by the acquisition authority object; and
acquiring the computing object into the logical network.

26. A method according to claim 25, wherein the assigning includes assigning node IDs in an order that is correlated to the presence lease of the computing object relative to the presence leases of other computing objects on the logical network without a priori knowledge of the presence leases of other computing objects.

27. A method according to claim 25, wherein the information collected by the ASA object in the discovery process includes a private ownership key, a nonce, a presence lease membership lease and at least one of an object serial number and a digest of an object serial number.

28. A method according to claim 25, wherein the information provided by the acquisition authority object includes the computing object's serial number digest and its Private Ownership Key (POK).

29. A method according to claim 25, wherein the information provided by the acquisition authority object includes the computing object's serial number digest and its Device Acquisition Key (DAK).

30. A method according to claim 29, wherein the DAK includes the computing object's POK and serial number digest and a 16-bit check code.

31. A method according to claim 25, wherein said assigning includes:
comparing the computing object's presence lease to a slow presence time out variable for the logical network.

32. A method according to claim 31, wherein if the computing object's presence lease is less than the slow presence time out variable, further including assigning a node ID that is in the range of node IDs for fast computing objects.

33. A method according to claim 31, wherein if the computing object's presence lease is greater than or equal to the slow presence time out variable, further including assigning a node ID that is in the range of node IDs for slow computing objects.

34. A method according to claim 25, further including reducing a range of free node IDs.

35. A method according to claim 34, wherein said reducing the range of free node IDs includes establishing a range of free IDs, the range of free IDs being between the first node of lesser or equal presence lease to at least one free node ID and the first node of greater presence lease after the at least one free node ID.

36. A method according to claim 35, wherein said reducing the range of free node IDs further includes choosing a node ID, calculated such that its ratio in the range is the ratio of the device's presence lease per the range of presence leases.

37. A method according to claim 25, wherein said acquiring includes sending an encrypted net assign message including a network key, AP variables for the logical network and its assigned node ID.

38. A method according to claim 37, wherein the encrypted net assign message is encrypted with the device's private ownership key and encryption nonce.

39. A method according to claim 38, wherein said acquiring further includes waiting for a pre-set time period allowing the computing object to retrieve the network time, and sign on the logical network.

40. A method according to claim 39, wherein said acquiring further includes sending an expunge node request message to the computing object and waiting for an expunge node response message.

41. A method according to claim 40, wherein said acquiring further includes, if a matching expunge node response message is not received within a predetermined amount of time, retrying the sending of an announce request message targeting the computing object by its computing object serial number to verify its presence on the physical network and to update the encryption nonce.

42. A method according to claim 40, wherein said acquiring further includes, if a matching announce response message is not received within a predetermined amount of time or the number of retries is at a ceiling, abandoning the acquisition.

43. At least one of an operating system, driver code, an application programming interface, a tool kit and a processing device for providing the method of acquiring of claim 25.

44. A modulated data signal carrying computer executable instructions for performing the method of claim 25.

45. A computing device comprising means for performing the method of claim 25.

46. An address space arbitrator (ASA) object communicatively coupled to an acquisition authority object (and/or person) for the management of a logical network and for keeping a logical network secure, even though the underlying physical network is a shared media, comprising:
an acquisition component that assigns a node identification (ID) to a computing object of at least one computing object on the logical network by sending at least one request message utilizing information collected by the ASA object in a discovery process and information provided by the acquisition authority object; and
acquiring the computing object into the logical network.

47. An ASA object according to claim 46, wherein the acquisition component assigns node IDs in an order that is correlated to the presence lease of the computing object relative to the presence leases of other computing objects on the logical network without a priori knowledge of the presence leases of other computing objects.

48. An ASA object according to claim 46, wherein the information collected by the ASA object in the discovery process includes a private ownership key, a nonce, a presence lease membership lease and at least one of an object serial number and a digest of an object serial number.

49. An ASA object according to claim 46, wherein the information provided by the acquisition authority object includes the computing object's serial number digest and its Private Ownership Key (POK).

50. An ASA object according to claim 46, wherein said acquisition component compares the computing object's presence lease to a slow presence time out variable for the logical network.

51. An ASA object according to claim 50, wherein if the computing object's presence lease is less than the slow presence time out variable, further including assigning a node ID that is in the range of node IDs for fast computing objects and if the computing object's presence lease is greater than or equal to the slow presence time out variable, further including assigning a node ID that is in the range of node IDs for slow computing objects.

52. An ASA object according to claim 46, wherein the acquisition component reduces the range of free node IDs.

53. An ASA object according to claim 52, wherein the acquisition component reduces the range of free node IDs by establishing a range of free IDs, the range of free IDs being between the first node of lesser or equal presence lease to at least one free node ID and the first node of greater presence lease after the at least one free node ID and by choosing a node ID, calculated such that its ratio in the range is the ratio of the device's presence lease per the range of presence leases.

54. An ASA object according to claim 46, wherein said acquisition component acquires the computing object by sending an encrypted net assign message including a network key, AP variables for the logical network and its assigned node ID.

55. An ASA object according to claim 54, wherein the encrypted net assign message is encrypted with the device's private ownership key and encryption nonce.

56. An ASA object according to claim 55, wherein said acquisition component waits for a pre-set time period allowing the computing object to retrieve the network time, and sign on the logical network.

57. An ASA object according to claim 56, wherein said acquisition component sends at least one of a ping request and an expunge node request message to the computing object and waits for at least one of a ping response and an expunge node response message, respectively.

58. An ASA object according to claim 57, wherein, if a matching expunge node response message is not received within a predetermined amount of time, said acquisition component resends an announce request message targeting the computing object by its computing object serial number to verify its presence on the physical network and to update the encryption nonce.

59. An ASA object according to claim 57, wherein, if a matching announce response message is not received within a predetermined amount of time or the number of retries is at a ceiling, the acquisition component abandons the acquisition.

60. A method for maintaining at least one computing object by an address space arbitrator (ASA) object in a logical network on a public medium, comprising:
renewing the logical network key when the existing logical network key compromises security; and
optimizing at least one application protocol (AP) variable based on at least one condition of the physical network and sending the at least one AP variable to at least one computing object on the logical network.

61. A method according to claim 60, wherein said sending of the at least one AP variable to the at least one computing object includes sending an encrypted AP variable message to a computing object the network ID, a source node ID, a destination node ID and the network time.

62. A method according to claim 60, wherein said renewing the logical network key includes renewing the logical network key periodically based upon when a counter associated with a nonce wraps around.

63. A method according to claim 60, wherein said renewing includes:
generating a cryptographically safe random number to be used as the new key; and
for each computing object on the logical network, sending an encrypted net key assign message including the new network key and verifying that the computing object received and processed.

64. A method according to claim 63, wherein said verifying includes checking that the encryption nonce of the computing object has been incremented by using an announce request message and announce response message exchange.

65. A method according to claim 60, wherein said renewing includes:
sending a net key commit message, encrypted with the old network key, which causes all computing objects on the logical network to roll over to the new network key.

66. A method according to claim 65, wherein said renewing include sending the net key commit message a plurality of times.

67. A method according to claim 66, wherein said renewing includes:
for any computing object that did not roll over to the new network key, detecting that the computing object did not roll over and updating the computing object to the new network key using a net assign message.

68. A method according to claim 67, wherein said detecting includes detecting that a computing object did not roll over because a message associated with the computing object comes through to the ASA as encrypted with the wrong network key.

69. A method according to claim 60, wherein said optimizing includes lowering network traffic due to a large number of computing objects on the logical network by at least one of (A) optimizing presence AP variables such that the total traffic generated by presence keep alives is lower, (B) increasing slow and fast time outs and (C) adjusting the address space cut off between fast and slow presence devices such that it corresponds to the first node with a presence lease of equal or greater value.

70. A method according to claim 60, Wherein said optimizing includes analyzing the test path information collected by the ASA to correct adverse computing object-specific transmission conditions, by retrieving information about weak transmitter nodes and optimizing data link-related transmission AP variables.

71. A method according to claim 60, wherein said sending of the at least one AP variable to at least one computing object on the logical network includes:
segmenting the address space in groups of consecutive node identifications (IDs) such that each group of at least one node (a) has the same AP variables values and (b) includes at most a predetermined number of nodes;
for each group of nodes, sending a write variables request message targeting the group, with a payload that includes the updated at least one AP variable value for the group; and
after the request, at least one of (A) waiting for either all qualifying write variables response messages to come back or (B) waiting for a time out period to expire.

72. A method according to claim 71, further including retrying the transaction for a computing object for which a correct write variables response was not received.

73. At least one of an operating system, driver code, an application programming interface, a tool kit and a processing device for providing the method of maintenance of claim 60.

74. A modulated data signal carrying computer executable instructions for performing the method of claim 60.

75. A computing device comprising means for performing the method of claim 60.

76. An address space arbitrator (ASA) object for the management of a logical network and for keeping a logical network secure, even though the underlying physical network is a shared media, comprising:
a maintenance component that renews the logical network key when the existing logical network key compromises security and optimizes at least one application protocol (AP) variable based on at least one condition of the physical network and sends the at least one AP variable to at least one computing object on the logical network.

77. An ASA object according to claim 76, wherein the maintenance component sends at least one AP variable to the at least one computing object includes by sending to a computing object an encrypted AP variable message the network ID, a source node ID, a destination node ID and the network time.

78. An ASA object according to claim 76, wherein the maintenance component renews the logical network key by periodically renewing the logical network key based upon when a counter associated with a nonce wraps around.

79. An ASA object according to claim 76, wherein the renewing by the maintenance component includes:
generating a cryptographically safe random number to be used as the new key; and
for each computing object on the logical network, sending an encrypted net key assign message including the new network key and verifying that the computing object received and processed.

80. An ASA object according to claim 79, wherein said verifying by the maintenance component includes checking that the encryption nonce of the computing object has been incremented by using an announce request message and announce response message exchange.

81. An ASA object according to claim 76, wherein the maintenance component sends a net key commit message, encrypted with the old network key, which causes all computing objects on the logical network to roll over to the new network key.

82. An ASA object according to claim 81, wherein the maintenance component sends the net key commit message a plurality of times.

83. An ASA object according to claim 82, wherein, for any computing object that did not roll over to the new network key, the maintenance component detects that a computing object did not roll over to the new network key and updates the computing object to the new network key using a net assign message.

84. An ASA object according to claim 83, wherein the maintenance component detects that a computing object did not roll over because a message associated with the computing object comes through to the ASA encrypted with the wrong network key.

85. An ASA object according to claim 76, wherein the optimizing includes lowering network traffic due to a large number of computing objects on the logical network by at least one of (A) optimizing presence AP variables such that the total traffic generated by presence keep alives is lower, (B) increasing slow and fast time outs and (C) adjusting the address space cut off between fast and slow presence devices such that it corresponds to the first node with a presence lease of equal or greater value.

86. An ASA object according to claim 76, wherein the optimizing includes analyzing the test path information collected by the ASA to correct adverse computing object-specific transmission conditions, by retrieving information about weak transmitter nodes and optimizing data link-related transmission AP variables.

87. An ASA object according to claim 76, wherein the sending of the at least one AP variable to at least one computing object on the logical network includes
segmenting the address space in groups of consecutive node identifications (IDs) such that each group of at least one node (a) has the same AP variables values and (b) includes at most a predetermined number of nodes;
for each group of nodes, sending a write variables request message targeting the group, with a payload that includes the updated at least one AP variable value for the group; and
after the request, at least one of (A) waiting for either all qualifying write variables response messages to come back or (B) waiting for a time out period to expire.

88. An ASA object according to claim 87, further including retrying the transaction for a computing object for which a correct write variables response was not received.

89. A computing device comprising an address space arbitrator (ASA) object communicatively coupled to an acquisition authority object, the ASA object for management of at least one computing object in a logical network on a public medium, the ASA object comprising:
a discovery component that discovers at least one serial number for at least one computing object in the logical network by sending at least one request message and receiving at least one response message in response to said at least one request message;
an acquisition component that assigns a node identification (ID) to a computing object of the at least one computing object on the logical network by sending at least one request message utilizing information collected by the discovery component process and information provided by the acquisition authority object and acquires the computing object into the logical network; and
a maintenance component that renews a logical network key when the existing logical network key compromises security and optimizes at least one application protocol (AP) variable based on at least one condition of the physical network and sends the at least one AP variable to at least one computing object on the logical network.

90. A computer readable medium comprising computer executable instructions for discovering at least one computing object by an address space arbitrator (ASA) object in communication with an acquisition authority object in a logical network on a public medium, comprising:
means for discovering at least a serial number for the computing object including:
means for sending at least one request message; and
means for receiving at least one response message in response to said at least one request message,
wherein said means for discovering is one of (A) initiated by the ASA object on a periodic basis and (B) initiated by the acquisition authority object when a computing object of the at least one computing object is instantiated on the public medium.

91. A computer readable medium comprising computer executable instructions for acquiring at least one computing object by an address space arbitrator (ASA) object communicatively coupled to an acquisition authority object in a logical network on a public medium, comprising:
means for assigning at the request of the acquisition authority object a node identification (ID) to a computing object of the at least one computing object by sending at least one request message utilizing information collected by the ASA object in a discovery process and information provided by the acquisition authority object; and
means for acquiring the computing object into the logical network.

92. A computer readable medium comprising computer executable instructions for maintaining at least one computing object by an address space arbitrator (ASA) object in a logical network on a public medium, comprising:
means for renewing the logical network key when the existing logical network key compromises security; and
means for optimizing at least one application protocol (AP) variable based on at least one condition of the physical network and sending the at least one AP variable to at least one computing object on the logical network.
